(19) United States
(12) Patent Application Publication
(10) Pub. No.: US 2019/0208904 A1
(43) Pub. Date: Jul. 11, 2019

(54) GRID STRUCTURE OF STORAGE RACK

(71) Applicant: CLAIR HOME PRODUCTS INC., Taoyuan City (TW)

(72) Inventor: Stephen Yu, Taoyuan City (TW)

(21) Appl. No.: 16/299,165

(22) Filed: Mar. 12, 2019

Related U.S. Application Data
(63) Continuation-in-part of application No. 15/285,487, filed on Oct. 5, 2016, now abandoned.

(30) Foreign Application Priority Data
Sep. 29, 2016 (TW) 105214620

(51) Int. Cl. A47B 55/02; A47B 57/58; B25H 3/04; A47F 5/00

(52) U.S. Cl. CPC A47B 55/02; A47B 57/581; B65G 1/0442; A47F 5/0056; B25H 3/04

(57) ABSTRACT

Disclosed is a grid structure of a storage rack, and the grid structure is formed by stacking a first frame with a second frame, and the first frame is formed by a multiple of parallel first wires with a spacing from one another, and the second frame is formed by a multiple of parallel second wires with a spacing from one another, and the first wires and the second wires are arranged perpendicular to each other respectively, and two side edges of the second frame have two latch portions with a shape corresponding to the first frame, so that objects of different lengths can be stored according to a different sequence of stacking the first and second frames, and the structure ensures the supporting effect of carrying heavy objects.

### CROSS-REFERENCE TO RELATED APPLICATIONS

This application is a continuation-in-part patent application of U.S. application Ser. No. 15/285,487 filed on Oct. 5, 2016, the entire contents of which are hereby incorporated by reference for which priority is claimed under 35 U.S.C. § 120.

### FIELD OF THE INVENTION

The present invention relates to the field of a multi-layer storage rack for carrying heavy objects, more particularly to a grid structure of a storage rack, and the grid structure is formed by two frames having wires arranged perpendicular to each other to facilitate users to store objects of different lengths, and the grid structure also ensures the supporting effect of carrying heavy objects.

### BACKGROUND OF THE INVENTION

### 1. Description of the Related Art

In general, the structural design of a conventional combinational storage rack includes a plurality corner pillars disposed at four corners of the storage rack and a plurality of partition layers for dividing the storage rack into a plurality of layers to achieve the effect of maximizing the utility of the storage space to facilitate the classification of objects. Most combination storage racks of this sort have a plurality of combining holes formed on a surface of each corner pillar, and bolts are used to fix the partition layers with a spacing to the corner pillars, or brackets are used to mount the partition layers to the corner pillars for latching and positioning the partition layers, and such design is very suitable for general DIY users, and the packing volume before assembling can be reduced effectively to lower the shipping cost.

The partition layers are mainly divided into the following two types: (1) a hole plate is formed by punching holes directly on a metal sheet, and such hole plate does not require soldering for fixation, but the support strength is weaker and thus the hole plate is just suitable for storage racks that carry a light load; and (2) a grid board formed by soldering staggered metal wires to form a grid, and the metal wires may be arranged into one, two or even three layers depending on the required support strength, and the grid board is suitable for storage racks that carry different loads. However, such grid board formed by soldering layers of metal wires incurs high manufacturing cost and material cost, and the total weight becomes greater and the greater weight incurs a higher level of difficulty and a higher cost for the transportation. In addition, the aforementioned hole plate or grid board does not have any structure for latching an object (particularly an object without all planar surface such as a cylindrical object) to the surface of the hole plate, or an object is placed on the grid board and set in a direction opposite to the direction of the wires, and thus there is an issue that the object often rolls or falls down from the hole plate or the grid board. Obviously, the conventional storage racks require improvements.

### 2. Summary of the Invention

Therefore, it is a primary objective of the present invention to overcome the drawbacks of the prior art by providing a grid structure of a storage rack, wherein the grid structure is formed by stacking two frames with wires perpendicular to each other, and capable of storing objects of different lengths by changing the stacking sequence of the two frames to achieve the effects of providing good positioning, preventing the object from rolling or falling down, and ensuring the supporting effect of carrying heavy objects.

To achieve the aforementioned objective, the present invention discloses a grid structure of storage rack, wherein the storage rack comprises four corner pillars vertically disposed at four corners of the storage rack respectively, a plurality of edge frames coupled to the corner pillars to form a rectangular frame space, and at least one grid disposed in the frame space, and the edge frames and the grid are combined to form a carrying plane for carrying heavy objects, and the grid is formed by stacking a first frame with a second frame, and the first frame is formed by a plurality of first parallel wires with a spacing from one another, and the second frame is formed by a plurality of second parallel wires with a spacing from one another, and the second frame is formed by a plurality of parallel second wires with a spacing from one another, and the first wires and the second wires are arranged perpendicular to each other, and two side edges of the second frame have two latch portions with a shape corresponding to the first frame respectively. The invention is capable of storing objects of different lengths by changing the sequence of stacking the first and second frames and ensuring a good supporting effect of carrying heavy objects.

In a preferred embodiment, each second wire is a metal solid wire or a metal hollow tube, and the second wire is greater than or equal to the first wire. If the hollow tube is used, a lightweight effect can be achieved to facilitate the transportation and assembling of the product.

In addition, the second wires and the first wires are perpendicular to one another respectively, so that the first wires and the second wires may be staggered into a “ [symbol] ” shaped structure, and the gaps among such structure can be adjusted to change the carrying effect of its use.

It is noteworthy that each second wire has a sectional shape corresponsive to a positive force direction of the carrying plane and in a flat elliptical shape and an aspect ratio falling within a range of 1.5:1-3.5:1. This range of aspect ratio is obtained after many experiments conducted by the inventor of the present invention. This aspect ratio varies with the diameter of a different wire used. For example, when the second wire with a smaller wire diameter is used, a smaller aspect ratio approximately equal to 1.5:1-2:1 may be selected; and when the second wire with a larger wire diameter is used, a larger aspect ratio approximately equal to 2:1-3.5:1 may be selected.

### BRIEF DESCRIPTION OF THE DRAWINGS

FIG. 1 is an exploded view of a preferred embodiment of the present invention;

FIG. 2A is a partial sectional view of an assembly of a preferred embodiment of the present invention;

FIG. 2B is a partial sectional view of an assembly of a preferred embodiment of the present invention;

FIG. 3A shows a first implementation mode of a preferred embodiment of the present invention;

FIG. 3B shows a first implementation mode of a preferred embodiment of the present invention;

FIG. 4A shows a second implementation mode of a preferred embodiment of the present invention; and

FIG. 4B shows a second implementation mode of a preferred embodiment of the present invention.

### DESCRIPTION OF THE PREFERRED EMBODIMENTS

The above and other objects, features and advantages of this disclosure will become apparent from the following detailed description taken with the accompanying drawings.

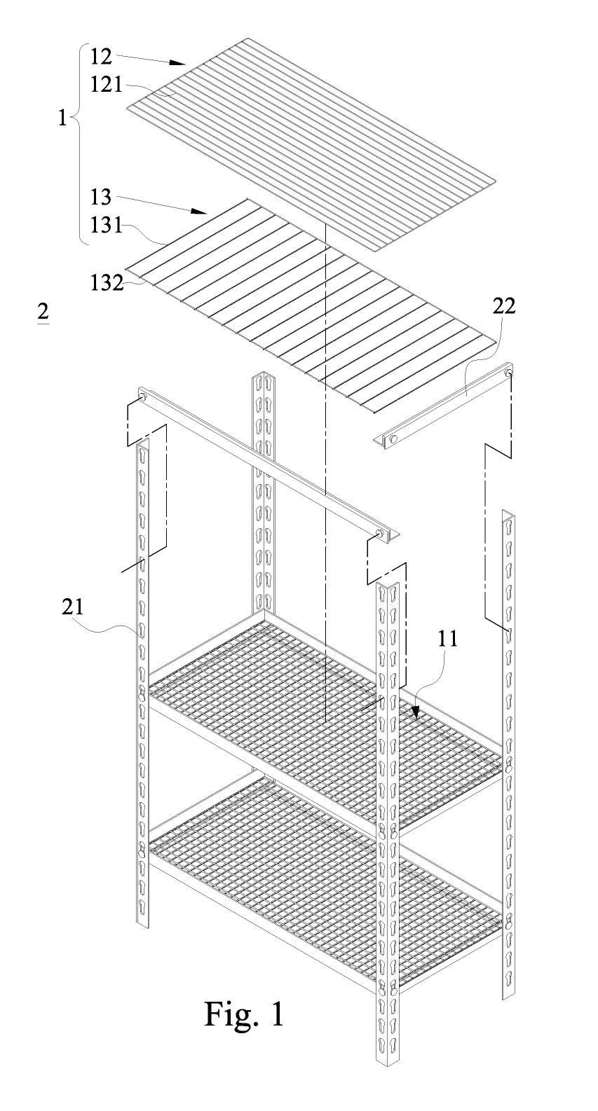

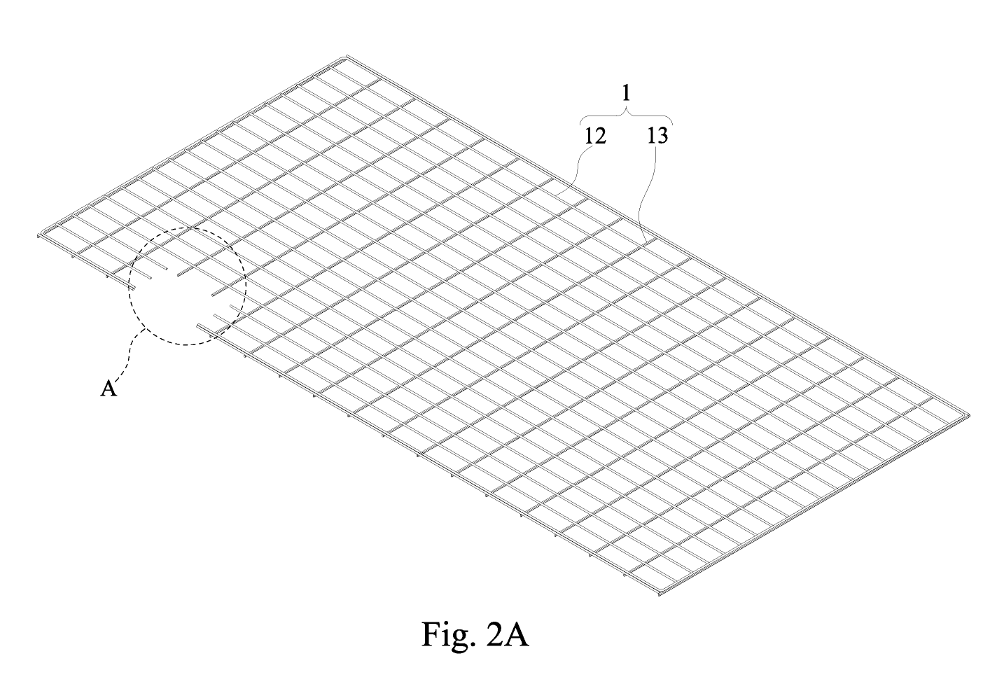

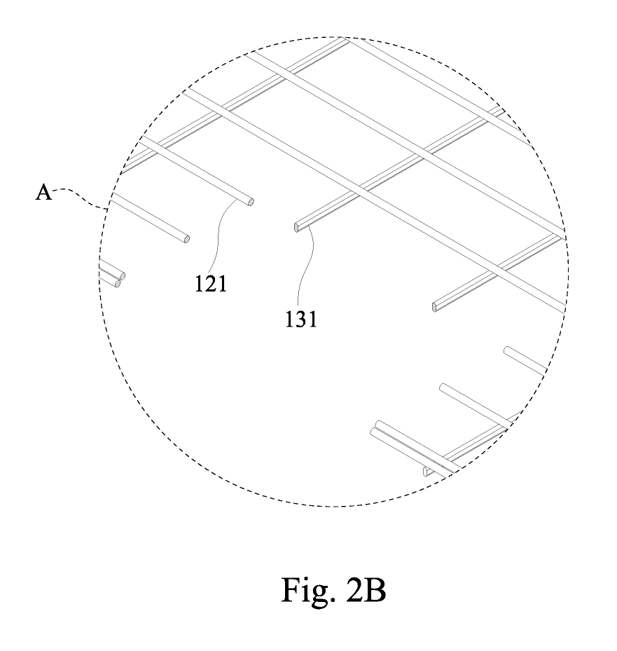

With reference to FIGS. 1 to 2B for an exploded view and a partial sectional view of a preferred embodiment of the present invention respectively and for another implementation mode of a second wire, the present invention provides a grid structure 1, and a storage rack 2 further comprises four corner pillars 21 disposed at four corners of the storage rack 2 respectively and coupled to form a plurality of edge frames 22 with a rectangular frame space, and at least one grid 1 disposed in the frame space, and the edge frames 22 and the grid 1 are combined to form a carrying plane 11 for carrying heavy objects, and the grid 1 is formed by stacking a first frame 12 with a second frame 13, and the first frame 12 is formed by a plurality of parallel first wires 121 with a spacing from each other as shown in the X-axis of the figure, and the second frame 13 is formed by a plurality of second parallel wires 131 with a spacing from each other as shown in the Y-axis of the figure, so that the first wires 121 and the second wires 131 are arranged perpendicular to each other. In addition, both side edges of the second frame 13 have two latch portions 132 with a shape corresponding to the first frame 12 respectively and provided for embedding the first frame 12 into the second frame 13, and the two latch portions 132 and the first wire 121 have the same diameter, and are designed with a “ [symbol] ” shaped staggered grid and planar surfaces, so that the latch portions 132 and the first wire 121 will not be separated from each other easily while moving. Wherein, each second wire 131 is a metal solid wire or a metal hollow tube, and each second wire 131 has a sectional shape corresponsive to a positive force direction of the carrying plane and in a flat elliptical shape, and the elliptical shape is formed by stamping or rolling the original circular wire, so that the weight remains unchanged. In addition, actual tests show that the aspect ratio of the sectional shape of the second wire 131 falls within a range of 1.5:1-3.5:1, and the aspect ratio may be changed according the wire diameter of the second wires 131. For example the second wire 131 with a smaller wire diameter may select an aspect ratio approximately equal to 1.5:1-2:1, and the second wire 131 with a large wire diameter may select an aspect ratio approximately equal to 2:1-3.5:1, because the cross-sectional area of a wire with a small wire diameter is also small. If the aspect ratio is too small, then the wire will become too flat or too thin, and the too-flat and too-thin wire is inconvenient for the soldering process and unable to improve the strength. Sometimes, the too-small aspect ratio may result in poor effects. Compared with the original wire, tests that the second wires 22 of the special shape will not increase the weight of materials, and the aspect ratio within this range can improve the supporting effect for carrying heavy objects effectively. It is noteworthy that the density is correlated to the support strength after the first wires 121 and the second wires 131 of the present invention are combined. The larger the distribution density, the greater the support strength. Meanwhile, a larger distribution density indicates a larger consumption of material, and creates a large challenge to the weight and material cost of the product. Therefore, it is a key point to select the distribution density of the wires and adopt different distribution densities for different parts.

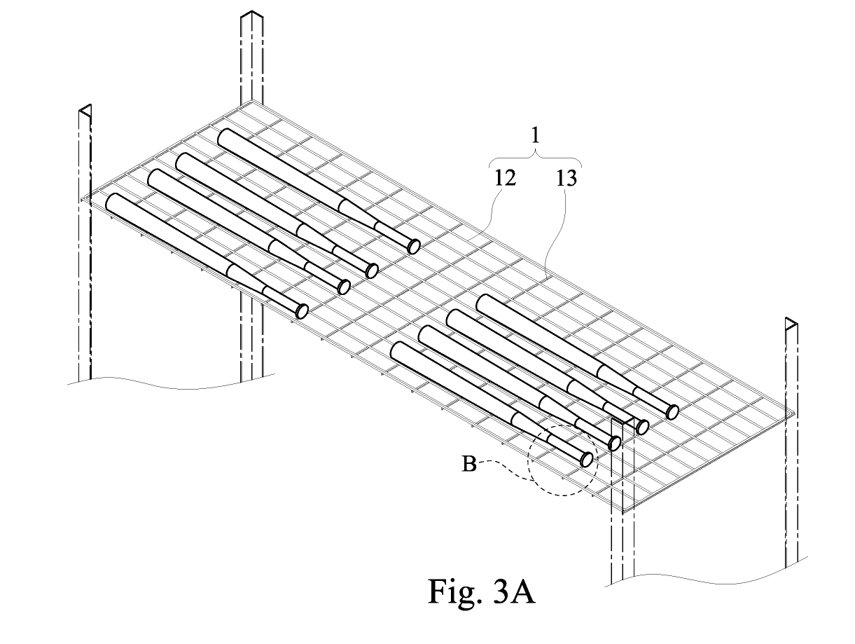

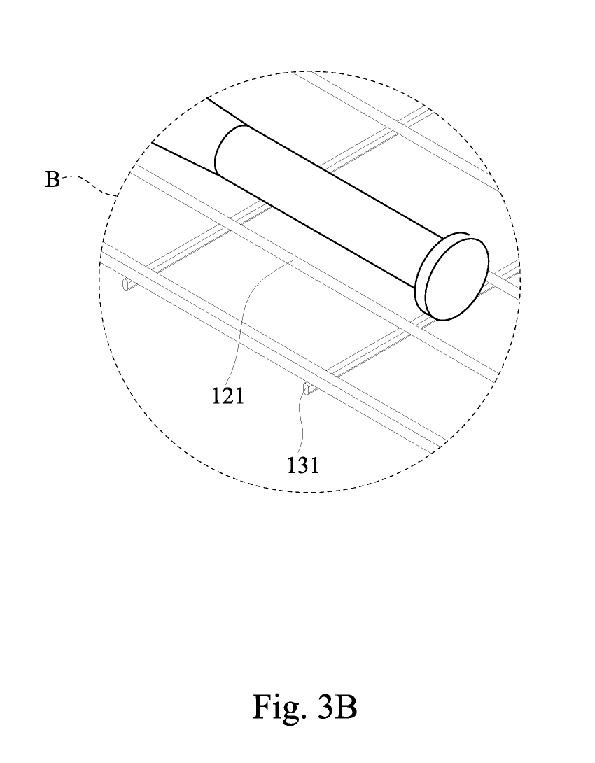

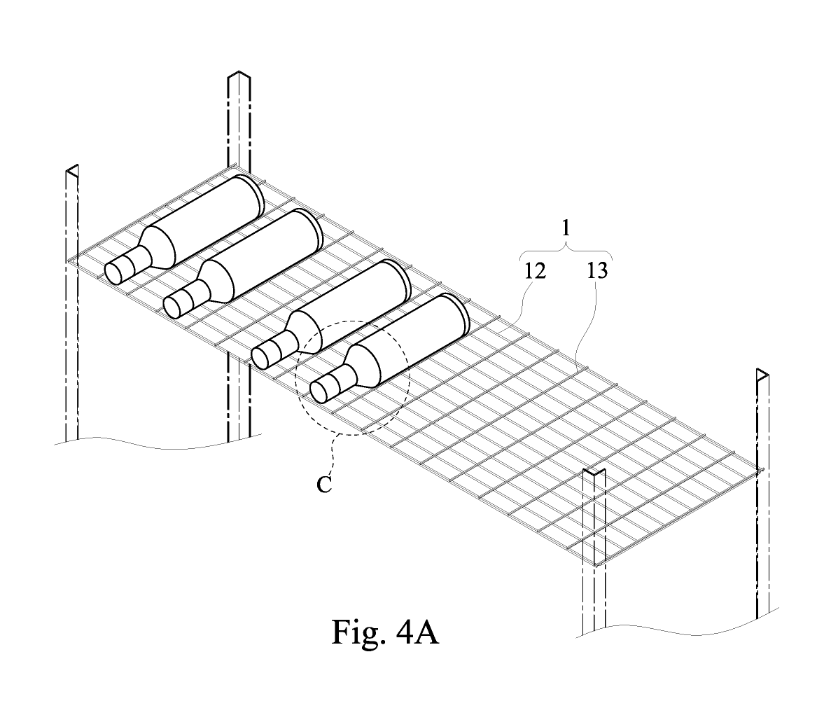

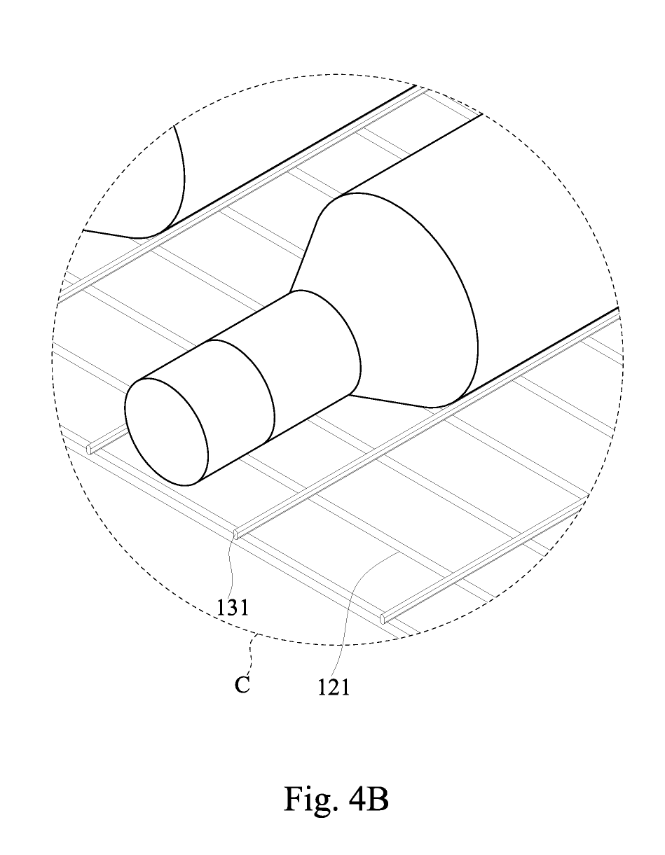

With reference to FIGS. 3A to 4B for the schematic views of the structure of two different implementation mode of a preferred embodiment of the present invention respectively, FIGS. 3A and 3B shows that when the second frame 13 of the grid structure of the present invention is stacked onto the first frame, the second wire 131 has a smaller length, so that it is suitable for storing an object with a smaller length such as wine bottle, and FIGS. 4A and 4B shows that when the first frame 12 of the grid structure of the present invention is stacked onto the second frame 13, the first wire 121 has a greater length, so that it is suitable for storing an object with a greater length such as bat.

What is claimed is:

1. A grid structure of a storage rack, and the storage rack comprising four corner pillars vertically disposed at four corners of the storage rack respectively, a plurality of edge frames coupled to one another to form a rectangular frame space and at least a grid disposed in the frame space, and the plurality of edge frames and the grid being combined to form a carrying plane for carrying heavy objects, and the grid being formed by stacking a first frame with a second frame, and the first frame being formed by a plurality of parallel first wires with a spacing from one another, and the second frame being formed by a plurality of parallel second wires with a spacing from one another, and the first wires and the second wires being arranged perpendicular to each other, and two side edges of the second frame having being two latch portions in a shape corresponsive to the first frame respectively.

2. The grid structure of a storage rack according to claim 1, wherein each of the plurality of parallel second wires is a metal solid wire.

3. The grid structure of a storage rack according to claim 1, wherein each of the plurality of parallel second wire is a metal hollow tube.

4. The grid structure of a storage rack according to claim 1, wherein the each of the plurality of parallel second wires and the first wires are perpendicular to one another.

5. The grid structure of a storage rack according to claim 4, wherein each of the plurality of parallel second wires has a sectional shape corresponsive to a positive force direction of the carrying plane which is in a flat elliptical shape, and an aspect ratio falling within a range of 1.5:1-3.5:1.
